(19) United States
(12) Patent Application Publication
(10) Pub. No.: US 2007/0054815 A1
(43) Pub. Date: Mar. 8, 2007

(54) Laundry scent customization

(75) Inventors: Andre Christian Convents, Diegem (BE); Johan Eshuis, Antwerpen (BE); Raf Gustaaf Alfons Degeyter, Donk (BE); James Charles Theophile Roger Burckett St. Laurent, Brussels (BE); Colin Christopher McCarney, Brussels (BE); Heidi Piper, Tervuren (BE); Patrick Jean-Francois Etesse, Brussels (BE); Joost Verburg, Antwerpen (BE); Philip John Porter, Cramlington (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/515,522

(22) Filed: Sep. 5, 2006

(30) Foreign Application Priority Data
Sep. 2, 2005 (EP) 05077009.8

(51) Int. Cl. C11D 3/50

(52) U.S. Cl. 510/101

(57) ABSTRACT

The present invention relates to laundry scent customization and laundry scent customized products, compositions, packages containing said products, assembly and articles of manufacture for laundry scent customization, kit of parts for providing laundry scent customization and methods of laundry scent customization.

### TECHNICAL FIELD

The present invention relates to laundry scent customization and laundry scent customized products, compositions, packages containing said products, assembly and articles of manufacture for laundry scent customization, kit of parts for providing laundry scent customization and methods of laundry scent customization.

### BACKGROUND OF THE INVENTION

Laundry products are known which contain different ingredients for affecting various functions in washing operations. One of the key ingredients is perfume. The “perfuming” function, initially inexistent, was progressively developed, first to cover the base odor, then to further deliver a pleasant odor during and after cleaning. The “perfume” attribute therefore became more and more important to consumers in addition to the cleaning attributes. A logical result of this trend is that an increased number of perfume variants are offered in the market place to satisfy consumers choice.

A principal strategy currently employed in imparting odors to consumer products is the admixing of the fragrance directly into the laundry product. There are however, several drawbacks to this strategy.

For example, the fragrance material can be too volatile, resulting in fragrance loss during manufacturing, storage, and use when admixed in the detergent. This is particularly the case in liquid detergents where perfumes are not protected. Many fragrance materials are also unstable over time. This again results in loss of fragrance during storage.

Perfumes need to be specifically designed to achieve a pleasant smell of the product and needs to deliver sufficient perfume material to the wash load after the wash process.

Perfume substances which modify or enhance the aroma of laundry products or impart a pleasing aroma thereto are well-known in the art. U.S. Pat. Nos. 4,131,555 and 4,228,026, are illustrative of patents which describe substances intended to impart a pleasing aroma or fragrance to liquid and granular detergent compositions. The described methods of preparation consist of mixing the perfume substances, in solid form, with the prepared detergent compositions to form a homogeneous composition. Perfumes which are in liquid form are conventionally added to liquid detergent compositions as a component thereof or sprayed upon the surface of granular detergent compositions. The perfume which is added to the detergent to provide a pleasant odor to the product also should be delivered to the garments in the wash process. However, these perfumes rapidly disperse and dilute during laundering in the aqueous wash solution along with the water-soluble components of the detergent composition. Only a relatively minor amount of the perfume is available to contact and adhere to the fabric being laundered, the major portion of the perfume being drained from the washing machine with the wash solution during the wash cycle. To the extent that some perfume is still in contact with the fabric after the washing operation, it tends to be dissipated subsequently during drying, such as, for example, in a gas or electric dryer in which the washed fabrics are tumbled at relatively high temperatures. While increasing the level and type of perfume to the detergent to maximize perfume deposition on garments in the wash, this is limited by cost and the perfume impact on neat product. As a result, fabrics laundered with conventional detergent compositions generally retain only a very faint perfume fragrance when formulated to achieve good smell on the neat product.

Another major drawback if laundry products are supplied to the consumer already containing a perfume is that said laundry products suffer from the same formulation disadvantages, i.e., their compositions are fixed. A particular perfume scent may not be appealing to one consumer but have a most appealing smell to another consumer. Also the amount of perfume contained in the laundry product may not coincide with the specific consumer desire regarding the strength of scent.

A partial solution to these drawbacks has been provided with for example in WO-A1-2005/042688, which discloses a kit comprising an unscented cleanser and a fragrance material in the form of effervescent tablets.

Therefore, supplying a laundry product and a plurality of different perfume compositions separately meet a yet unsatisfied consumer demand. More generally separating the scenting from the other functions of the laundry product allows the consumer to decide which perfume scent and which perfume amount to use. It allows the formulator to incorporate a pleasing amount and type of perfume on the laundry or fabric softener product, while delivering a separate perfume which is tailored to maximize perfume deposition on garments in the dilute wash process. In addition, a given consumer may prefer a given perfume. It is also likely that a consumer will have different perfume preferences depending on the types of fabrics being laundered or the setting where those fabrics will be worm. Specifically, it is expected that consumers will desire one fragrance for linens, a separate fragrance for fabrics worn at social occasions and special events and additional fragrances for undergarments, work clothes, athletic apparel etc. Furthermore, while it is preferred that a given kit will contain different types of different perfumes, it is likewise preferred that the kit will contain multiple doses or articles of the perfume to allow for repeat usage of that perfume at different usage conditions throughout the laundry process.

It will be appreciated by those skilled in the art of formulating laundry products that the apparent way of utilizing pure perfume as an additive to unperfumed compositions is not feasible since perfume cannot be emulsified with surfactants or solvents by the consumer in usual laundry products without special efforts. Also the use of pure perfume directly in the wash or rinse is not economical since most of the fragrance would be lost by being washed away, evaporated or absorbed by the material of the wash appliance. Measuring the minute amounts of perfume required, would add undesirable complexity for the consumer if it was supplied as a pure perfume.

In addition, attempts to prepare amido or ester amine/esterquat fabric conditioning agents without added perfume have demonstrated that the presence of the perfume is necessary in order to obtain emulsions having a stable viscosity. The perfume has been found to serve a physical/chemical role in the achievement of emulsions which maintain viscosity and which do not separate after periods of storage, since perfume-free emulsions of the type described herein are not viscosity stable after periods of ageing.

There is therefore, a need in the art for a method to form scent customized laundry products and methods which can effectively provide a perfume to fabrics being laundered such that the finished laundered fabrics have added appeal to the user.

Equally, there remains a need in the art for a method to readily introduce perfumes by the consumer himself in the home. Preferably, this method should be done in a way that it is very, convenient, easy and enjoyable for the user. It should also solve the contraction of providing a pleasant smell to the detergent or fabric softener, while deliver good freshness to the washed garments. The method should also preferably avoid the need for high shear mechanical agitation and equipment. Further, there is a need for a method which apart from incorporating perfume into an unscented base formulation, will do so without adversely impacting the rheological and physical stability of the final product and the efficiency of both the base formulation as well as the perfume.

Laundry scent customization has been reported in the prior art. GB2304740 discloses a method of treating laundry comprises the steps of applying a fragrance to the laundry via an iron. The addition of a few drops of after-shave or perfume to the water in the reservoir of a steam iron endow laundry with a delicate pleasant fragrance. IT 1298898 discloses the addition to the wash of perfume out of a dropper device. EP 391 087 describes a washing process the fragrance material is fed to the wash or rinsing liquid in the form of a water-soluble or water-dispersing solid containing at least 1 gram of fragrance material, namely as a tablet or capsule of appropriate size, towards the end of the wash process, namely during the last wash cycle or the final rinsing phase.

In contrast with the present invention, the art has not been aware of one of the most important of the present inventive concepts, that following instructions, perfumes could be separately selected and dosed to a neutral scented composition, or that the user could, following instructions, could formulate his own scent customized laundry products which would be most suitable for washing the particular laundry, and yet, would be able to be formulated into various laundry products. The present invention gives the consumer the flexibility to formulate and customize his own laundry product to be used in the context of a unitary laundry operation.

Therefore, applicants have developed the articles, kits and method according to the present invention which are solving the aforementioned needs, satisfying the consumer demand for simplicity, flexibility of the amount and of the scent of perfumes and which allow the use of compounds of perfume compositions which may ordinarily display storage problems when being combined in a single product. It also allows the consumer to combine different perfumes and layer them in detergents and fabric softeners separately. It also uniquely solves the incompatibility of the delivering a non intrusive perfume to the base detergent and/or fabric softener and a perfume specifically designed to deposit on the fabric.

The overall benefits of the present invention can be defined as the improvement of perfume delivery on fabrics from such compositions as to make it not only consumer-noticeable, but also long-lasting.

Application of the present invention also allows for slowing down or preventing release of perfume through long periods of shelf storage. Such a concept also allows for using much lower levels of perfume in product since much less perfume is wasted and the consumer can tailor the perfume levels to the specific needs of the load

In a technical aspect the present invention allows to formulate laundry products containing ingredients which have limited tolerance or which are even destructive towards perfumes especially upon longer term storage. On the other hand, perfume compositions or perfume compounds which so far have not found wide spread utilization for reasons of compatibility, stability or commercial reasons.

These and other advantages will become more apparent in the detailed description of the invention.

### SUMMARY OF THE INVENTION

In a first embodiment, the present invention is directed to a method for a laundry operation comprising the steps of: a) selecting a neutral scented base composition; b) selecting a perfume composition; c) dosing and dispensing the perfume composition into the neutral scented base composition thereby forming a unitized dose of customized laundry product; d) dispensing the unitized dose of customized laundry product formed in step c) to the laundry washing liquor.

According to a second embodiment of the present invention, it is provided a kit for providing a unitized dose of scented customized laundry product comprising: a) a selection from a neutral scented base composition; b) a selection from a class of perfume compositions; c) means for the consumer to select, dose and dispense the perfume compositions into the neutral scented base composition thereby forming a unitized dose of customized laundry product for use in a laundry operation.

According to a third embodiment of the present invention, an assembly is provided comprising a plurality of perfume compositions, the assembly further comprising means to instruct a consumer how to select and/or dose and/or dispense one or more of said perfume compositions into a neutral scented base composition thereby forming a unitized dose of customized laundry product for use in a laundry operation.

The present invention further encompasses an article of manufacture comprising a perfume composition, the article further comprising means for the consumer to select, dose and dispense the perfume composition into a neutral scented base composition thereby forming a unitized dose of customized laundry product for use in a laundry operation.

### DETAILED DESCRIPTION OF THE INVENTION

As used herein, “neutral scented” is referred to as those compositions which comprise either purified raw materials to prevent malodour and/or odour blocking agents and/or perfume which neutralizes the odour of malodours ingredients.

Neutral scented compositions also encompass those compositions which contain purified ingredients such as surfactant, polymer and enzyme components which have been purified to eliminate residual components with high odour impact, such as amine or sulphur containing compounds. Equally, said neutral scented compositions include those compositions which contain known neutralizing perfume components such as musk, ionones and some esters/terpenes.

Neutral Scented Base Composition

The neutral scented base composition is preferably selected from an unscented laundry detergent composition and/or an unscented fabric conditioning composition.

It should be understood that ‘neutral’ as referred to in the description does describe that the base detergent does not have a recognizable odour which can interfere with the perfume additives. This can be achieved by either eliminating the base odour from the detergent or fabric softener with purified ingredient material to become basically odour free. Alternatively the base composition contains malodour counteractive ingredients which alleviate the perception of malodour. A third option includes the addition of neutral perfumes which are masking perfumes which are required to overcome undesirable odours of fabric treatment composition ingredients. These perfumes are typically highly volatile materials or perfume raw materials with a neutral odour profile which is compatible with all additive perfumes. A neutral scented base composition can in certain embodiments, comprise a low odour intensity characteristic perfume designed to reinforce the base composition's identity.

Neutral Scented Laundry Detergent Base Composition

A neutral scented laundry detergent base composition is provided in the article, method and kit of the present invention.

The neutral scented laundry detergent base composition useful herein is used in laundering a fabric article to remove undesirable materials such as dirt, oils, chemicals, body soils, etc. The fabric article is laundered with the neutral scented base laundry detergent composition. Accordingly, the laundry detergent composition contains at least one detersive surfactant selected from the group consisting of an amphoteric surfactant, an anionic surfactant, a cationic surfactant, a non-ionic surfactant, a zwitterionic surfactant, and combinations thereof.

Nonlimiting examples of detersive surfactants useful in the detergent composition include, the conventional C11-C18 alkyl benzene sulfonates and primary, branched-chain and random C10-C20 alkyl sulfates, the C10-C18 secondary (2,3) alkyl sulfates of the formula CH3(CH2)x(CHOSO3<−>M<+>)CH3 and CH3(CH2)y(CHOSO3<−>M<+>)CH2CH3 where x and (y+1) are integers of at least about 7, preferably at least about 9, and M is a water-solubilizing cation, especially sodium, unsaturated sulfates such as oleyl sulfate, the C10-C18 alkyl alkoxy sulfates; especially EO 1-7 ethoxy sulfates), C10-C18 alkyl alkoxy carboxylates (especially the EO 1-5 ethoxycarboxylates), the C10-18 glycerol ethers, the C10-C18 alkyl polyglycosides and their corresponding sulfated polyglycosides, and C12-C18 alpha-sulfonated fatty acid esters. If desired, the conventional nonionic and amphoteric surfactants such as the C12-C18 alkyl ethoxylates including the so-called narrow peaked alkyl ethoxylates and C6-C12 alkyl phenol alkoxylates (especially ethoxylates and mixed ethoxy/propoxy), C12-C18 betaines and sulfobetaines, C10-C18 amine oxides, and the like, can also be included in the overall compositions. The C10-C18 N-alkyl polyhydroxy fatty acid amides can also be used. Typical examples include the C12-C18 N-methylglucamides. See WO 92/06154 to Cook, et al., published Apr. 16, 1992. Other sugar-derived surfactants include the N-alkoxy polyhydroxy fatty acid amides, such as C10-C18 N-(3-methoxypropyl) glucamide. The N-propyl through N-hexyl C12-C18 glucamides can be used for low sudsing. C10-C20 conventional soaps may also be used. If high sudsing is desired, the branched-chain C10-C16 soaps may be used. Mixtures of anionic and nonionic surfactants are especially useful. Preferably, the laundry detergent composition comprises, by weight, at least about 0.01%; more preferably at least about 0.1%; even more preferably at least about 1%; and even more preferably still, from about 1% to about 55% detersive surfactant. In addition to a detersive surfactant, a laundry detergent composition may further contain one or more adjunct ingredients such as an anti-redeposition agent, a bleach, a bleach activator, a brightener, a builder, a carrier, a chelant, a clay soil removal agent, a dispersant, a dye, a dye-transfer inhibitor, an enzyme, an enzyme stabilization method, a fabric softening active, a filler, a hydrotrope, a processing aid, a soil release polymer, a solvent, a suds booster, a suds supressor, etc.

While the neutral scented base laundry detergent composition may contain one or more adjunct ingredients, for example, a fabric softening active, it is distinguished from a fabric conditioning composition in that the neutral scented base laundry detergent composition is applied to the fabric in the wash cycle, and thus, its primary function is to clean and remove undesirable materials from the fabric article.

The neutral scented base laundry detergent composition is not limited in physical form, and may be a granule, a powder, a liquid, a gel, a paste, a tablet, or a bar. Preferably, the laundry detergent composition's form is a granule, a powder, a liquid, or a gel, and more preferably, the laundry detergent composition is a laundry detergent composition in a liquid, or a gel form. Without intending to be limited by theory, it is believed that a liquid or a gel form may be more gentle on the fabric article, may be more soluble at low temperatures, and/or may be more effective on enzyme-susceptible soils. Specific, non-limiting examples of a laundry detergent composition useful herein include those described in, for example, WO 95/33044 to Vinson, et al., published on Dec. 7, 1995; WO 99/09126 to Bettiol, et al., published on Feb. 25, 1999; PCT Patent Application No. U.S. Ser. No. 00/00839 to Showell, et al., filed on Jan. 13, 2000; U.S. Pat. No. 5,916,862 to Morelli, et al., issued on Jun. 29, 1999; U.S. Pat. No. 5,565,145 to Watson, et al., issued on Oct. 15, 1996; U.S. Pat. No. 5,470,507 to Fredj, et al., issued on Nov. 28, 1995; U.S. Pat. No. 5,466,802 to Panadiker, et al., issued on Nov. 14, 1995; U.S. Pat No. 5,460,752 to Fredj, et al., issued on Oct. 24, 1995; U.S. Pat. No. 5,458,810 to Fredj, et al., issued on Oct. 17, 1995; U.S. Pat. No. 5,458,809 to Fredj, et al., issued on Oct. 17, 1995; US 2003/0104969 to Caswell, et al. and US 2005/0026793 to Caswell et al.

Neutral Scented Base Fabric Conditioning Composition

A neutral scented base fabric conditioning composition is provided in the method and kit of the present invention. The fabric conditioning composition useful herein is applied to the surface and/or the interior of a fabric article to modify the properties of the fabric article and to provide one or more benefits such as softness, skin comfort, reduced static, increased fluffiness, improved fibre and colour maintenance, reduced wrinkling, reduced tangling, reduced surface friction, etc. The fabric article is thereby conditioned with the fabric conditioning composition.

Useful neutral scented base fabric conditioning compositions may be in liquid, solid, gel, or sheet form, and are typically applied to a fabric article in the wash cycle, in the rinse cycle, and/or during the drying cycle. Preferably, the fabric conditioning composition is applied to the fabric in the rinse cycle, and/or in the drying cycle. In a highly preferred embodiment of the present invention, the fabric conditioning composition is a liquid fabric conditioning composition which is applied to the fabric article during the rinse cycle of a washing process. The neutral scented base fabric conditioning composition typically contains from about 0.1% to about 90%, preferably from about 0.5% to about 70%, and more preferably from about 1% to about 40% of a fabric softening active such as an impalpable smectite clay, a silicone derivative, a cationic fabric softening active, and/or a mixture thereof. Preferred fabric softening actives include quaternary ammonium compounds or amine precursors thereof, cationic ammonium softening compounds, non-ionic softening compounds, and mixtures thereof. More preferred fabric softening actives and fabric conditioning compositions include those disclosed in U.S. Pat. No. 4,062,647 to Storm and Nirschl, issued Dec. 13, 1977; U.S. Pat. No. 4,375,416 to Crisp, et al., issued Mar. 1, 1983; U.S. Pat. No. 4,291,071 to Harris, et al., issued Sep. 22, 1981; and PCT Patent Application U.S. Ser. No. 99/15056 to Bryant, et al., filed on Jul. 1, 1999.

In a highly preferred embodiment, the fabric conditioning composition here is a clear, transparent, translucent or milky white fabric conditioning composition. Specific examples of highly preferred fabric conditioning compositions include those disclosed in U.S. Pat. No. 5,747,443 to Wahl, et al., issued May 5, 1998, and in U.S. patent application Ser. Nos. 08/621,019; 08/620,627; 08/620,767; 08/620,513; 08/621,285; 08/621,299; 08/621,298; 08/620,626; 08/620,625; 08/620,772; 08/621,281; 08/620,514; and 08/620,958, all filed Mar. 22, 1996, and all having the title “CONCENTRATED, STABLE, PREFERABLY CLEAR, FABRIC SOFTENING COMPOSITION”.

The fabric conditioning composition may further comprise one or more adjunct ingredients such as a solvent, an antibacterial agent, a deposition aid, a pH buffer, a dye, an optical brightener, a viscosity/dispersability modifier, a dye transfer inhibition agent, fabric surface modifiers such as silicones and polymers, a soil release agent, a phase stabilizer, a stabilizer, and a mixture thereof. Preferred adjunct ingredients include a surfactant, a pH buffer, a viscosity modifier, a dye, and a mixture thereof.

The neutral scented base compositions of the present inventions are those compositions which comprise no perfume raw material but comprise purified formulation ingredients to eliminate malodour residues, usually amine or sulphur based compounds.

The neutral scented base compositions of the present inventions are those compositions which comprise unique odour blocking ingredients or which comprise neutral masking perfumes such as ionones, musks, terpenes or esters. Very suitable perfume raw materials for such neutral masking perfumes are Prenyl acetate, Ligustral, Floralozone, Delta Damascone, Undecavertol, alpha ionone, Beta ionone, Gamma methyl ionone, 4-Tertiary Butyl Cyclohexyl Acetate, Delta Muscenone, Habanolide, Heletolide, orange terpenes and eucalyptol.

WO9850010 describes a select combination of perfume materials which help to mask malodours associated with the use of malodour-producing polymers and/or malodour-producing liquid carriers in the compositions. US2004253199 describes a process for reducing a malodour formed as a result of fatty acid derivative degradation and/or organic amine degradation taking place in a fabric care base contained in a fabric article. WO 02066591 discloses an enzyme having lysostaphin activity capable of reducing malodour from laundry.

Malodour counteractant and/or odour blockers are described in US 2005124512, EP 1533415, US 2004248762, EP 1167507 and US 20050026793 which refers to malodour control agents.

Formulation of perfume compositions which have a specific octanol/water partitioning coefficient (P). Octanol/water partitioning coefficient of a perfume ingredient is the ratio between its equilibrium concentration in octanol and in water. This base composition is characterized in that said neutral base composition comprises from about 0.01% to about 10% of a non residual perfume which has at least about 50% of components with a ClogP less than 2.5., ClogP being the calculated octanol/water partitioning coefficient (P) expressed as the logarithm to the base 10, logP.

The logP of many perfume ingredients has been reported; for example, the Pomona92 database, available from Daylight Chemical Information Methods, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach on Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present invention.

The boiling points of many perfume ingredients are given in, e.g., “Perfume and Flavor Chemicals (Aroma Chemicals),” S. Arctander, published by the author, 1969, incorporated herein by reference. Other boiling point values can be obtained from different chemistry handbooks and databases, such as the Beilstein Handbook, Lange's Handbook of Chemistry, and the CRC Handbook of Chemistry and Physics. When a boiling point is given only at a different pressure, usually lower pressure than the normal pressure of 760 mm Hg, the boiling point at normal pressure can be approximately estimated by using boiling point-pressure nomographs, such as those given in “The Chemist's Companion,” A. J. Gordon and R. A. Ford, John Wiley & Sons Publishers, 1972, pp. 30-36. When applicable, the boiling point values can also be calculated by computer programs, based on molecular structural data, such as those described in “Computer-Assisted Prediction of Normal Boiling Points of Pyrans and Pyrroles,” D. T. Stanton et al, J. Chem. Inf. Comput. Sci., 32 (1992), pp. 306-316, “Computer-Assisted Prediction of Normal Boiling Points of Furans, Tetrahydrofurans, and Thiophenes,” D. T. Stanton et al, J. Chem. Inf. Comput. Sci., 31 (1992), pp. 301-310, and references cited therein, and “Predicting Physical Properties from Molecular Structure,” R. Murugan et al, Chemtech, June 1994, pp. 17-23. All the above publications are incorporated herein by reference. Thus, when a perfume composition which is composed primarily of ingredients having a B.P. at about 250 DEG C., or higher, and a ClogP of about 3, or higher, is used the perfume is very effectively deposited on fabrics and remains substantive on fabrics after the rinsing and drying (line or machine drying) steps.

Perfume Compositions

used herein the term “perfume” is used to indicate any odoriferous material that is subsequently released into the aqueous bath and/or onto fabrics contacted therewith. The perfume will most often be liquid at ambient temperatures. A wide variety of chemicals are known for perfume uses, including materials such as aldehydes, ketones, and esters. More commonly, naturally occurring plant and animal oils and exudates comprising complex mixtures of various chemical components are known for use as perfumes. The perfumes herein can be relatively simple in their compositions or can comprise highly sophisticated complex mixtures of natural and synthetic chemical components, all chosen to provide any desired odour. Typical perfumes can comprise, for example, woody/earthy bases containing exotic materials such as sandalwood, civet and patchouli oil. The perfumes can be of a light floral fragrance, e.g. rose extract, violet extract, and lilac. The perfumes can also be formulated to provide desirable fruity odours, e.g. lime, lemon, and orange. Further, it is anticipated that so-called “designer fragrances” that are typically applied directly to the skin will be used when desired by the consumer. Likewise, the perfumes delivered in the compositions and articles of the present invention may be selected for an aromatherapy effect, such as providing a relaxing or invigorating mood. As such, any material that exudes pleasant or otherwise desirable odours can be used as a perfume active in the compositions and articles of the present invention.

Preferably, at least about 25%, more preferably at least about 50%, even more preferably at least about 75%, by weight of the perfume is composed of fragrance material selected from the group consisting of aromatic and aliphatic esters having molecular weights from about 130 to about 250; aliphatic and aromatic alcohols having molecular weights from about 90 to about 240; aliphatic ketones having molecular weights from about 150 to about 260; aromatic ketones having molecular weights from about 150 to about 270; aromatic and aliphatic lactones having molecular weights from about 130 to about 290; aliphatic aldehydes having molecular weights from about 140 to about 200; aromatic aldehydes having molecular weights from about 90 to about 230; aliphatic and aromatic ethers having molecular weights from about 150 to about 270; and condensation products of aldehydes and amines having molecular weights from about 180 to about 320; and essentially free from nitromusks and halogenated fragrance materials.

More preferably, at least about 25%, more preferably at least about 50%, most preferably at least about 75%, by weight of the perfume is composed of fragrance material selected from the group consisting of: 1 Common Name Chemical Type Chemical Name Approx. M.W. Adoxal aliphatic 2,6,10-trimethyl-9-undecen-1-al 210 aldehyde allyl amyl glycolate ester allyl amyl glycolate 182 allyl cyclohexane ester allyl-3-cyclohexyl propionate 196 propionate amyl acetate ester 3-methyl-1-butanol acetate 130 amyl salicylate ester amyl salicylate 208 anisic aldehyde aromatic 4-methoxy benzaldehyde 136 aldehyde aurantiol schiff base condensation product of 305 methyl anthranilate and hydroxycitronellal bacdanol aliphatic alcohol 2-ethyl-4-(2,2,3-trimethyl-3-208 cyclopenten-1-yl)-2-buten-1-ol benzaldehyde aromatic benzaldehyde 106 aldehyde benzophenone aromatic ketone benzophenone 182 Benzyl acetate ester benzyl acetate 150 Benzyl salicylate ester benzyl salicylate 228 beta damascone aliphatic ketone 1-(2,6,6-trimethyl-1-cyclo-192 hexen-1-yl)-2-buten-1-one beta gamma hexanol alcohol 3-hexen-1-ol 100 buccoxime aliphatic ketone 1,5-dimethyl-oxime 167 bicyclo[3,2,1]octan-8-one Cedrol alcohol octahydro-3,6,8,8-tetramethyl-222 1H-3A,7-methanoazulen-6-ol cetalox ether dodecahydro-3A,6,6,9A-236 tetramethylnaphtho[2,1B]-furan cis-3-hexenyl acetate ester cis-3-hexenyl acetate 142 cis-3-hexenyl salicylate ester beta, gamma-hexenyl 220 salicylate citronellol alcohol 3,7-dimethyl-6-octenol 156 citronellyl nitrile nitrile geranyl nitrile 151 clove stem oil natural coumarin lactone coumarin 146 cyclohexyl salicylate ester cyclohexyl salicylate 220 cymal aromatic 2-methyl-3-(para iso propyl 190 aldehyde phenyl)propionaldehyde decyl aldehyde aliphatic decyl aldehyde 156 aldehyde delta damascone aliphatic ketone 1-(2,6,6-trimethyl-3-cyclo-192 hexen-1-yl)-2-buten-1-one dihydromyrcenol alcohol 3-methylene-7-methyl octan-156 7-ol dimethyl benzyl carbinyl ester dimethyl benzyl carbinyl 192 acetate acetate ethyl vanillin aromatic ethyl vanillin 166 aldehyde ethyl-2-methyl butyrate ester ethyl-2-methyl butyrate 130 ethylene brassylate macrocyclic ethylene tridecan-1,13-dioate 270 lactone eucalyptol aliphatic 1,8-epoxy-para-menthane 154 epoxide eugenol alcohol 4-allyl-2-methoxy phenol 164 exaltolide macrocyclic cyclopentadecanolide 240 lactone flor acetate ester dihydro-nor-cyclopentadienyl 190 acetate florhydral aromatic 3-(3-isopropylphenyl)butanal 190 aldehyde frutene ester dihydro-nor-cyclopentadienyl 206 propionate galaxolide ether 1,3,4,6,7,8-hexahydro-258 4,6,6,7,8,8-hexamethylcyclopenta-gamma-2-benzopyrane gamma decalactone lactone 4-N-hepty-4-hydroxybutanoic 170 acid lactone gamma dodecalactone lactone 4-N-octyl-4-hydroxy-butan-oic 198 acid lactone geraniol alcohol 3,7-dimethyl-2,6-octadien-1-ol 154 geranyl acetate ester 3,7-dimethyl-2,6-octadien-1-yl 196 acetate geranyl nitrile ester 3,7-diemthyl-2,6-149 octadienenitrile helional aromatic alpha-methyl-3,4, 192 aldehyde(methylenedioxy)hydrocinnamaldehyde heliotropin aromatic heliotropin 150 aldehyde Hexyl acetate ester hexyl acteate 144 Hexyl cinnamic aldehyde aromatic alpha-n-hexyl cinnamic 216 aldehyde aldehyde Hexyl salicylate ester hexyl salicylate 222 hydroxyambran aliphatic alcohol 2-cyclododecyl-propanol 226 hydroxycitronellal aliphatic hydroxycitronellal 172 aldehdye ionone alpha aliphatic ketone 4-(2,6,6-trimethyl-1-192 cyclohexenyl-1-yl)-3-buten-2-one ionone beta aliphatic ketone 4-(2,6,6-trimethyl-1-192 cyclohexen-1-yl)-3-butene-2-one ionone gamma methyl aliphatic ketone 4-(2,6,6-trimethyl-2-206 cyclohexyl-1-yl)-3-methyl-3-buten-2-one iso E super aliphatic ketone 7-acetyl-1,2,3,4,5,6,7,8-234 octahydro-1,1,6,7,tetramethyl naphthalene iso eugenol ether 2-methoxy-4-(1-propenyl) 164 phenol iso jasmone aliphatic ketone 2-methyl-3-(2-pentenyl)-2-166 cyclopenten-1-one koavone aliphatic acetyl di-isoamylene 182 aldehyde Lauric aldehyde aliphatic lauric aldehyde 184 aldehyde lavandin natural lavender natural lemon CP natural major component d-limonene d-limonene/orange terpenes alkene 1-methyl-4-iso-propenyl-1-136 cyclohexene linalool alcohol 3-hydroxy-3,7-dimethyl-1,6-154 octadiene linalyl acetate ester 3-hydroxy-3,7-dimethyl-1,6-196 octadiene acetate Irg 201 ester 2,4-dihydroxy-3,6-dimethyl 196 benzoic acid methyl ester Lyral aliphatic 4-(4-hydroxy-4-methyl-pentyl) 210 aldehyde 3-cylcohexene-1-carboxaldehyde majantol aliphatic alcohol 2,2-dimethyl-3-(3-178 methylphenyl)-propanol mayol alcohol 4-(1-methylethyl) cyclohexane 156 methanol methyl anthranilate aromatic amine methyl-2-aminobenzoate 151 methyl beta naphthyl ketone aromatic ketone methyl beta naphthyl ketone 170 methyl cedrylone aliphatic ketone methyl cedrenyl ketone 246 methyl chavicol ester 1-methyloxy-4,2-propen-148 1-yl benzene methyl dihydro jasmonate aliphatic ketone methyl dihydro jasmonate 226 methyl nonyl acetaldehyde aliphatic methyl nonyl acetaldehyde 184 aldehyde Musk indanone aromatic ketone 4-acetyl-6-tert butyl-1,1-244 dimethyl indane Nerol alcohol 2-cis-3,7-dimethyl-2,6-154 octadien-1-ol nonalactone lactone 4-hydroxynonanoic acid, 156 lactone norlimbanol aliphatic alcohol 1-(2,2,6-trimethyl-cyclohexyl)-226 3-hexanol orange CP natural major component d-limonene P.T. bucinal aromatic 2-methyl-3(para tert 204 aldehyde butylphenyl)propionaldehyde para hydroxy phenyl aromatic ketone para hydroxy phenyl 164 butanone butanone patchouli natural phenyl acetaldehyde aromatic 1-oxo-2-phenylethane 120 aldehyde phenyl acetaldehyde aromatic phenyl acetaldehyde dimethyl 166 dimethyl acetal aldehyde acetal phenyl ethyl acetate ester phenyl ethyl acetate 164 phenyl ethyl alcohol alcohol phenyl ethyl alcohol 122 phenyl ethyl phenyl acetate ester 2-phenylethyl phenyl acetate 240 phenyl hexanol/phenoxanol alcohol 3-methyl-5-phenylpentanol 178 polysantol aliphatic alcohol 3,3-dimethyl-5-(2,2,3-221 trimethyl-3-cyclopenten-1-yl)-4-penten-2-ol Prenyl acetate ester 2-methylbuten-2-ol-4-acet-ate 128 rosaphen aromatic 2-methyl-5-phenyl pentanol 178 alcohol sandalwood natural alpha-terpinene aliphatic alkane 1-methyl-4-iso-136 propylcyclohexadiene-1,3 terpineol (alpha terpineol alcohol para-menth-1-en-8-ol, para-154 and beta terpineol) menth-1-en-1-ol terpinyl acetate ester para-menth-1-en-8-yl acetate 196 tetra hydro linalool aliphtic alcohol 3,7-dimethyl-3-octanol 158 tetrahydromyrcenol aliphatic alcohol 2,6-dimethyl-2-octanol 158 Tonalid/musk plus aromatic ketone 7-acetyl-1,1,3,4,4,6-258 hexamethyl tetralin undecalactone lactone 4-N-heptyl-4-hydroxybutanoic 184 acid lactone undecavertol alcohol 4-methyl-3-decen-5-ol 170 undecyl aldehyde aliphatic undecanal 170 aldehyde undecylenic aldehyde aliphatic undecylenic aldehyde 168 aldehyde vanillin aromatic 4-hydroxy-3-152 aldehyde methoxybenzaldehyde verdox ester 2-tert-butyl cyclohexyl acetate 198 vertenex ester 4-tert-butyl cyclohexyl acetate 198 and mixtures thereof.

During the laundry process, a substantial amount of perfume that is added to the wash and/or the rinse cycle is lost with the water and in the subsequent drying cycle (either line drying or machine drying). This has resulted in both a waste of unusable perfume that are not deposited on the laundered fabrics, and a contribution to the general air pollution from the release of volatile organic compounds to the air. It is therefore preferable that at least about 25%, more preferably at least about 50%, even more preferably at least about 75%, by weight of the perfume is composed of enduring perfume ingredients. These enduring perfume ingredients are characterized by their boiling points (B. P.) and their ClogP value. The enduring perfume ingredients of this invention have a B. P., measured at the normal, standard pressure of 760 mm Hg, of about 240° C. or higher, preferably of about 250° C. or higher, and a ClogP of about 2.7 or higher, preferably of about 2.9 or higher, and even more preferably of about 3.0 or higher. The enduring perfume ingredients tend to be substantive and remain on fabric after the laundry washing and drying process.

The boiling points of many perfume ingredients are given in, e.g., “Perfume and Flavor Chemicals (Aroma Chemicals),” Steffen Arctander, published by the author, 1969, incorporated herein by reference. Other boiling point values can be obtained from different chemistry handbooks and data bases, such as the Beilstein Handbook, Lange's Handbook of Chemistry, and the CRC Handbook of Chemistry and Physics. When a boiling point is given only at a different pressure, usually lower pressure than the normal pressure of 760 mm Hg, the boiling point at normal pressure can be approximately estimated by using boiling point-pressure nomographs, such as those given in “The Chemist's Companion,” A. J. Gordon and R. A. Ford, John Wiley & Sons Publishers, 1972, pp. 30-36. The boiling point values can also be estimated via a computer program that is described in “Development of a Quantitative Structure—Property Relationship Model for Estimating Normal Boiling Points of Small Multifunctional Organic Molecules”, David T. Stanton, Journal of Chemical Information and Computer Sciences, Vol. 40, Nov. 1, 2000, pp. 81-90.

Perfume compositions composed of enduring perfume ingredients that have both a boiling point of about 250.degree. C. or higher and a ClogP of about 3.0 or higher, are very effectively deposited on fabrics and remain substantive on fabrics after rinsing and drying.

Non-limiting examples of the preferred enduring perfume ingredients of the present invention include: benzyl salicylate, adoxal, allyl cyclohexane propionate (trade name for allyl-3-cyclohexyl propionate), alpha damascone, ambrettolide (trade name for oxacycloheptadec-10-en-2-on-e), ambretone (trade name for 5-cyclohexadecen-1-one), ambroxan, amyl cinnamic aldehyde,amyl cinnamic aldehyde dimethyl acetal, amyl salicylate, ambrinol 20t (trade name for 2,5,5-trimethyl-octahydro-2-naph-thol), iso E super (trade name for 7-acetyl-1,2,3,4,5,6,7,8-octahydro-1,1,-6,7,tetramethyinaphthalene), anandol (trade name for 2-ethyl-4-(2,2,3-trimethyl-3-cyclopenten-1-yl)-2-buten-1-ol), aurantiol (trade name for hydroxycitronellal-methyl anthranilate), benzyl benzoate, nirvanol (trade name for 4-penten-2-ol,3,3-dimethyl-5-(2,2,3 trimethyl-3-cyclopenten-1-yl)-), undecalactone (trade name for 4-N-heptyl-4-hydroxybutanoic acid lactone), beta naphthol methyl ether, bourgeonal (trade name for 3-(4-tert butylphenyl)-propanal), cyclohexadecenone (trade name for cis-/trans-cyclohexadec-8-en-1-one), caryophyllene extra, methyl cedrylone (trade name for methyl cedrenyl ketone), neobutenone (trade name for 4-penten-1-one, 1-(5,5-dimethyl-1-cyclohexen-1-yl)), cedramber, cedac (trade name for cedrynyl acetate), cedrol (trade name for octahydro-3,6,8,8-tetramethyl-1-H-3A,7-methanoazulen-6-ol), musk C-14 (trade name for ethylene dodecane dioate), cis-3-hexenyl salicylate (trade name for beta, gamma-hexenyl salicylate), citrathal, citronellyl propionate, galaxolide (trade name for 1,3,4,6,7,8-hexahydro-4,6,6,7,8,8-hexamethlycyclopenta-gamma-2-benzop-yrane), cyclohexyl salicylate, cymal (trade name for 2-methyl-3-(para iso propyl phenyl)propionaldehyde), damascone beta (trade name for 1-(2,6,6-trimethylcyclohexen-1-yl)-2-buten-1-one), damascenone (trade name for 1-(2,6,6-trimethyl-1,3-cyclohexadien-1-yl)-2-buten-1-one), delta damascone (trade name for 1-(2,6,6-trimethyl-3-cyclo-hexen-1-yl)-2-buten-1-one), dihydro iso jasmonate, diphenyl methane, dupical (trade name for 4-(tricyclo(5.2.1.0 2,6)decylidene-8)-butanal), diphenyl oxide, gamma-dodecalactone (trade name for 4-N-octyl-4-hydroxy-butanoic acid lactone), delta-dodecalactone, ethyl cinnamate, ebanol, ethylene brassylate (trade name for ethylene tridecan-1,13-dioate), florhydral (trade name for 3-(3-isopropylphenyl)butanol), habanolide (trade name for oxacyclohexadec-12+13-en-2-one), hexyl cinnamic aldehyde (trade name for alpha-n-hexyl cinnamic aldehyde), hexyl salicylate, hydroxyambran (trade name for 2-cyclododecyl-propanol), ionone alpha (trade name for 4-(2,6,6-trimethyl-1-cyclohexenyl-1-yl)-3-buten-2-one), ionone beta (trade name for 4-(2,6,6-trimethyl-1-cyclohexen-1-yl)-3-butene-2-one), ionone gamma methyl (trade name for 4-(2,6,6-trimethyl-2-cyclohexyl-1-yl)-3-methyl-3-buten-2-one), ionone methyl, iralia, iso butyl quinoline, lauric aldehyde, p. t. bucinal (trade name for 2-methyl-3(para tertbutylphenyl)propionaldehyde), musk ketone, musk indanone (trade name for 4-acetyl-6-tert butyl-1,1-dimethyl indane), musk plus (trade name for 7-acetyl-1,1,3,4,4,6-hexamethyl tetralin), octalynol (trade name for 1-naphthalenol, 1,2,3,4,4a,5,8,8a,octahydro-2,2,6,8-tetramethyl), ozonil (trade name for tridecen-2-nitrile), phantolide (trade name for 5-acetyl-1,1,2,3,3,6-hexamethylindan), phenafleur (trade name for cyclohexyl phenyl ethyl ether), phenyl ethyl benzoate, phenyl ethyl phenyl acetate (trade name for 2-phenylethyl phenyl acetate), vetiveryl acetate, sandalwood, amyl benzoate, amyl cinnamate, cadinene, cedryl acetate, cedryl formate, cinnamyl cinnamate, cyclamen aldehyde, exaltolide (trade name for 15-hydroxypentadecanoic acid, lactone), geranyl anthranilate, hexadecanolide, hexenyl salicylate, linayl benzoate, 2-methoxy naphthalene, methyl cinnamate, methyl dihydrojasmonate, beta-methyl napthyl ketone, musk tibetine, myristicin, delta-nonalactone, oxahexadecanolide-10, oxahexadecanolide-11, patchouli alcohol, phenyl heptanol, phenyl hexanol (trade name for 3-methyl-5-phenylpentanol), alpha-santalol, thibetolide (trade name for 15-hydroxypentadecanoic acid, lactone), delta-undecalactone, gamma-undecalactone, yara-yara, methyl-N-methyl anthranilate, benzyl butyrate, benzyl iso valerate, citronellyl isobutyrate, delta nonalactone, dimethyl benzyl carbinyl acetate, dodecanal, geranyl acetate (trade name for 3,7-dimethyl-2,6-octadien-1-yl acetate), geranyl isobutyrate, gamma-ionone, para-isopropyl phenylacetaldehyde, tonalid (trade name for 7-acetyl-1,1,3,4,4,6-hexamethyl tetralin), iso-amyl salicylate, ethyl undecylenate, benzophenone, beta-caryophyllene, dodecalactone, lilial (trade name for para-tertiary-butyl-alpha-methyl hydrocinnamic aldehyde), and mixtures thereof.

The preferred perfume compositions used in the present invention contain at least 4 different enduring perfume ingredients, preferably at least 5 enduring perfume ingredients, more preferably at least 6 different enduring perfume ingredients, and even more preferably at least 7 different enduring perfume ingredients. Most common perfume ingredients which are derived from natural sources, are composed of a multitude of components. When each such material is used in the formulation of the preferred perfume compositions of the present invention, it is counted as one single ingredient, for the purpose of defining the invention.

To create the perfume additive of the invention, an optimized formulation needs to be designed to assure good solubility of the perfume and miscibility in the detergent and/or fabric softener across a range of levels. The formulation is optimized with some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., diluting and stabilizing some other perfume ingredients.

The perfume compositions of the present invention can also comprise some low odor detection threshold perfume ingredients. The odor detection threshold of an odorous material is the lowest vapor concentration of that material which can be olfactorily detected. The odor detection threshold and some odor detection threshold values are discussed in, e.g., “Standardized Human Olfactory Thresholds”, M. Devos et al, IRL Press at Oxford University Press, 1990, and “Compilation of Odor and Taste Threshold Values Data”, F. A. Fazzalari, editor, ASTM Data Series DS 48A, American Society for Testing and Materials, 1978, both of said publications being incorporated by reference. The use of small amounts of perfume ingredients that have low odor detection threshold values can improve perfume odor character, even though they are not as substantive as the enduring perfume ingredients disclosed hereinabove.

Perfume ingredients having a significantly low detection threshold, useful in the perfume composition of the present invention, are selected from the group consisting of allyl amyl glycolate, ambrox (trade name for 1,5,5,9-tetramethyl-1,3-oxatricyclotridecane), anethole, bacdanol (trade name for 2-ethyl-4-(2,2,3-trimethyl-3-cyclopenten-1-yl)-2-buten-1-ol), benzyl acetone, benzyl salicylate, butyl anthranilate, calone, cetalox (trade name for dodecahydro-3A,6,6,9A-tetramethylnaphtho[2,1B]-furan), cinnamic alcohol, coumarin, cyclogalbanate, Cyclal C (trade name for 3-cyclohexene-1-carboxaldehyde, 3,5-dimethyl-), cymal (trade name for 2-methyl-3-(para iso propylphenyl)propionaldehyde), damascenone (trade name for 1-(2,6,6-trimethyl-1,3-cyclohexadien-1-yl)-2-buten-1-one), alpha-damascone, 4-decenal, dihydro isojasmonate, gamma-dodecalactone (trade name for 4-N-octyl-4-hydroxy-butanoic acid lactone), ebanol, ethyl anthranilate, ethyl-2-methyl butyrate, ethyl methylphenyl glycidate, ethyl vanillin, eugenol (trade name for 4-allyl-2-methoxy phenol), flor acetate (trade name for dihydro-nor-cyclopentadienyl acetate), florhydral (trade name for 3-(3-isopropylphenyl)butanol), fructone (trade name for ethyl-2-methyl-1,3-dioxolane-2-acetate), frutene (trade name for dihydro-nor-cyclopentadienyl propionate), heliotropin, herbavert, cis-3-hexenyl salicylate (trade name for beta, gamma-hexenyl salicylate), indole, ionone alpha (trade name for 4-(2,6,6-trimethyl-1-cyclohexenyl-1-yl)-3-buten-2-one), ionone beta (trade name for 4-(2,6,6-trimethyl-1-cyclo-hexen-1-yl)-3-butene-2-one), iso cyclo citral, isoeugenol (trade name for 2-methoxy-4-(1-propenyl)phenol), alpha-isomethylionone, keone, lilial (trade name for para-tertiary butyl alpha-methyl hydrocinnamic aldehyde), linalool (trade name for 3-hydroxy-3,7-dimethyl-1,6-octadiene), lyral (trade name for 4-(4-hydroxy-4-methyl-pentyl)3-cylcohexene-1-carboxaledehyde), methyl anthranilate (trade name for methyl-2-aminobenzoate), methyl dihydrojasmonate, methyl heptine carbonate, methyl isobutenyl tetrahydropyran, methyl beta naphthyl ketone, methyl nonyl ketone, beta naphthol methyl ether, nerol (trade name for 2-cis-3,7-dimethyl-2,6-octad-ien-1-ol), para-anisic aldehyde, para hydroxy phenyl butanone, phenyl acetaldehyde (trade name for 1-oxo-2-phenylethane), gamma-undecalactone, undecylenic aldehyde, vanillin (trade name for 4-hydroxy-3-methoxybenzald-ehyde), and mixtures thereof. These materials are preferably present at low levels in addition to the enduring perfume ingredients, typically less than about 20%, preferably less than about 15%, more preferably less than about 10%, by weight of the total perfume compositions of the present invention. It is understood that these materials can be used a levels higher than 20% and even up to 100% of the total perfume composition. Some enduring perfume ingredients also have low odor detection threshold.

The following non-limiting examples exemplify enduring perfume compositions: Perfume Ingredients Wt. % Enduring Perfume A Benzyl Salicylate 10 Coumarin 5 Ethyl Vanillin 2 Ethylene Brassylate 10 Galaxolide 15 Hexyl Cinnamic Aldehyde 20 Gamma Methyl lonone 10 Lilial 15 Methyl Dihydrojasmonate 5 Patchouli 5 Tonalid 3 Total 100 Enduring Perfume B Vertinex (4 -tertiary butyl cyclohexyl acetate) 3 Methyl cedrylone 2 Verdox 3 Galaxolide 14 Tonalid 5 Hexyl salicylate 4 Benzyl salicylate 4 Hexyl cinnamic aldehyde 6 P.T. Bucinal 6 Musk indanone 7 Ambrettolide 2 Sandela 5 Phentolide 2 Vetivert acetate 4 Patchouli 2 Geranyl phenylacetate 6 Okoumal 6 Citronellyl acetate 3 Citronellol 5 Phenyl ethyl alcohol 5 Ethyl vanillin 2 Coumarin 1 Flor acetate 1 Linalool 2 Total 100

The perfume active may also include pro-fragrances such as acetal profragrances, ketal pro-fragrances, ester pro-fragrances (e.g., digeranyl succinate), hydrolyzable inorganic-organic pro-fragrances, and mixtures thereof. These pro-fragrances may release the perfume material as a result of simple hydrolysis, or may be pH-change-triggered pro-fragrances (e.g. pH drop) or may be enzymatically releasable pro-fragrances.

Pro-fragrances are suitably described in the following: U.S. Pat. No. 5,378,468 Suffis et al., issued Jan. 3, 1995; U.S. Pat. No. 5,626,852 Suffis et al., issued May 6, 1997; U.S. Pat. No. 5,710,122 Sivik et al., issued Jan. 20, 1998; U.S. Pat. No. 5,716,918 Sivik et al., issued Feb. 10, 1998; U.S. Pat. No. 5,721,202 Waite et al., issued Feb. 24, 1998; U.S. Pat. No. 5,744,435 Hartman et al., issued Apr. 25, 1998; U.S. Pat. No. 5,756,827 Sivik, issued May 26, 1998; U.S. Pat. No. 5,830,835 Sevems et al., issued Nov. 3, 1998; U.S. Pat. No. 5,919,752 Morelli et al., issued Jul. 6, 1999; WO 00/02986 published Jan. 20, 2000, Busch et al.; and WO 01/04248 published Jan. 18, 2001, Busch et al. all of which are incorporated herein by reference.

Perfume Fixative

Optionally, the perfume active or mixture of actives may be combined with a perfume fixative. The perfume fixative materials employed herein are characterized by several criteria that make them especially suitable in the practice of this invention. Dispersible, toxicologically acceptable, non-skin irritating, inert to the perfume, degradable and/or available from renewable resources, and relatively odorless fixatives are used. The use of perfume fixatives is believed to slow the evaporation of more volatile components of the perfume.

Examples of suitable fixatives include members selected from the group consisting of diethyl phthalate, musks, and mixtures thereof. If used, the perfume fixative may comprise from about 10% to about 50%, and preferably from about 20% to about 40%, by weight of the perfume.

Perfume Carrier Materials

The perfume can be contained or encapsulated in a carrier to prevent premature loss, as well as to avoid a strong product perfume odor. The encapsulation can be in the form of molecular encapsulation, such as inclusion in a complex with cyclodextrin, coacevate microencapsulation wherein the perfume droplet is enclosed in a solid wall material, and “cellular matrix” encapsulation wherein solid particles containing perfume droplets are stably held in cells. In addition, perfumes and other organic fabric care actives can be absorbed onto the surface or adsorbed into the pores of porous carrier materials or embedded in a matrix, such as a starch or sugar matrix. As used herein, “porous carrier materials” includes porous solids selected from the group consisting of amorphous silicates, crystalline non-layer silicates, layered silicates, calcium carbonates, calcium/sodium carbonate double salts, sodium carbonates, clays, zeolites, sodalites, alkali metal phosphates, macroporous zeolites, chitin microbeads, carboxyalkylcelluloses, carboxyalkylstarches, foams, porous starches, chemically modified starches, and mixtures thereof.

A suitable method of perfume delivery takes into account the effectiveness, the efficiency, and the cost of each method. Cyclodextrin/perfume complex is preferred for its effectiveness and ease of processing. The complex protects and retains the perfume ingredients from physical effects (e.g., no rupture/perfume loss during processing, packaging, shipping, and storing of the product, or perfume loss from diffusion) and from chemical effects (e.g., degradation during storage).

Perfume microcapsules, e.g., coacevate microcapsule where the perfume droplet is enclosed in a solid wall material or “cellular” ) microcapsule where a solid particle contains perfume droplets stably held in the cells, are preferred for their perfume loading which can be as high as 60-80%. However, the encapsulation process is more demanding, and perfume leakage due to breakage of the microcapsules during processing, packaging, shipping, and storing of the product tends to occur.

Porous particles can also be used to retain perfume and release it slowly in use. The crude matrix particles where the perfume is embedded in a matrix, such as a starch or sugar matrix are inexpensive and easy to produce. The perfume loading is medium. However, the activation to release perfume can be less effective than the encapsulation methods described herein above.

The various types of agents useful in the neutral scented base compositions are described hereinafter. The compositions containing particulate compositions can optionally include one or more other detergent adjunct materials or other materials for assisting or enhancing cleaning performance, treatment of the substrate to be cleaned, or to modify the aesthetics of the detergent composition (e.g., colorants, dyes, etc.).

Kit for Providing a Unitized Dose of Scented Customized Laundry Product

In one embodiment, the present invention is directed to a kit for providing a unitized dose of scented customized laundry product comprising: a) a selection from a neutral scented base composition; b) a selection from a class of perfume compositions; c) means for the consumer to select, dose and dispense the perfume compositions into the neutral scented base composition thereby forming a unitized dose of customized laundry product for use in a laundry operation.

By “unitized dose of scented customized laundry product”, it is meant herein the quantity of scented laundry product which is recommended/desired for a unitary laundry operation, and which is sufficient to achieve the pursued benefits.

When said neutral scented composition is selected from a neutral scented base detergent composition, the quantity of recommended scented laundry product is typically comprised between 5 ml and 300 ml, preferably between 10 and 100, more preferably between 20 and 70, most preferably between 30 and 60.

When said neutral scented composition is selected to be a neutral scented fabric conditioning composition, the quantity of recommended scented laundry product is typically comprised between 2 ml and 300 ml, preferably between 10 and 100, more preferably between 20 and 80, most preferably between 30 and 50.

According to the present invention said means for the consumer to select, dose and dispense the perfume compositions into the neutral scented base composition, comprise droppers, sprays, bowls, cups, caps, discs, spout, spray nozzle, pump, washing machine dispensers, dispensing devices, or a combination thereof. Preferably, said means are calibrated to deliver a predetermined amount of perfume. Alternatively, said means comprise beads, bags, flakes, chips, films, suppositories having a unit dose of perfume.

Preferred kits according to the present invention are those whereby the means for dosing and/or dispensing the neutral scented base composition and the perfume composition are similar or identical in shape. Suitable means for use herein may be selected form the group consisting of boxes, bottles, pouches, envelopes, cans, tubes, atomizers, aerosols, beads, flakes, bags, ad mixtures thereof.

Preferred kit according to the present invention are those whereby the neutral scented base composition is selected from a neutral scented base detergent composition and/or a neutral scented fabric conditioning composition.

Specific preferred kit for providing a unitized dose of scented customized laundry product is characterized in that the neutral scented base composition and the perfume composition are liquid, the neutral scented base composition is contained in a bottle, and the means for selecting, dosing and dispensing the liquid perfume composition is provided as a range of perfume droppers, the kit further containing a dispensing device such as for example a bowl which fits on top of said bottle for dispensing the perfume into the neutral scented base composition. According to an even more preferred execution of this embodiment, the kit is characterized in that it comprises a neutral scented base laundry detergent composition and a neutral scented base fabric conditioning composition which are both in liquid form and both contained in separate bottles, and wherein said dispensing device fits on top of either of said bottles for dispensing the perfume into either or both of the neutral scented base composition.

Devices which can dispense laundry compositions into one or more stages of a machine laundering operation are disclosed in U.S. Pat. No. 4,186,573 and PCT Publication WO 01/25526. Products in the form of a pouch or container which can be used for the staged or delayed dispensing of laundry additive materials into a machine fabric laundering operation are disclosed in U.S. Pat. Nos. 4,026,131; 4,260,054; and 4,588,080; and in Canadian Patent 1,133,712. Arrangements involving a dispensing device and a pre-packaged amount of laundry additive material for staged or timed dispensing during a laundering operation are disclosed in U.S. Pat. Nos. 4,379,515 and 4,882,917 and in PCT Publications WO 01/07703 and WO 01/0770. Dispensing devices have been common-place in domestic laundry processes. Typically the dispensing devices are distributed with detergent products by the manufacturers of these products. The consumer gets benefits of improved washing performance when using dispensing devices compared to the more traditional method of dispensing laundry products by means of a drawer usually located near the top of the washing machine. This is because the so-called “heart-of-the-wash” effect results in less product being lost in the washing machine sump, and therefore more product being available to dissolve rapidly in the wash liquor, thereby promoting the washing performance. Furthermore the consumer benefits from improved convenience and less messiness compared with the drawer dispensing method.

Another specific preferred kit for providing a unitized dose of scented customized laundry product is characterized in that the neutral scented base composition and the perfume composition are liquid, the neutral scented base composition is contained in a bottle, and the means for selecting, dosing and dispensing the liquid perfume composition is provided as a range of perfume discs, the bottle further containing a dosing chamber integrated on top of the bottle for connecting with the perfume discs. According to an even more preferred execution of this embodiment, the kit is characterized in that it comprises a neutral scented base laundry detergent composition and a neutral scented base fabric conditioning composition which are both in liquid form and both contained in separate bottles containing a dosing chamber integrated on top of the bottle.

Yet another preferred kit according to the invention is characterized in that the neutral scented base composition is contained in beads and the means for selecting, dosing and dispensing the perfume composition is provided as a range of beads.

Typically, the kit is preferably characterized in that said neutral scented base composition comprises from about 0.01% to about 10% of a non residual perfume which has at least about 50% of components with a ClogP less than 2.5., ClogP being the calculated octanol/water partitioning coefficient (P) expressed as the logarithm to the base 10, logP further characterized in that said perfume composition comprising from about 0.01% to about 10% of a perfume which has at least about 50% of components with a ClogP more than 2,7, ClogP being the calculated octanol/water partitioning coefficient (P) expressed as the logarithm to the base 10, logP.

According to the present invention, the kit of the present invention comprises a set of instructions directing the user to choose and/or combine one or more perfume compositions to achieve the desired benefit. For example, the kit may comprise a perfume composition base which is of a given scent which may be useful to use in combination for laundry cleaning of sports items in the home of the present invention.

Preferably the kit contains instructions for the consumer to admix the perfume compositions into the neutral scented base compositions prior to adding into the laundry washing liquor.

Specific instructions are instructions to admix the perfume composition and the neutral scented base composition in amounts so that the weight ratio of the perfume composition to the base composition is in the range from about 1:5 to about 1:100, preferably from about 1:10 to about 1:75.

Preferably, the instructions will refer to customization with a neutral scented base composition whereby a perfume composition is combined with a base composition to customize the method according to the present invention. The instructions may include various types of fabrics, various types of stains, the corresponding additives, and the effective amount (which may be presented in one or more dosage units) of the specific compositions recommended for enhancing or delivering the desired benefits in terms of perfume, cleaning and/or softening performance.

The instructions may also direct the user to choose a pretreating composition, which is to be applied to the laundry fabrics prior to the laundering process, which is to be applied during the laundering process in the device, to enhance or deliver the desired benefits of the method of the present invention. The instructions may also be related to the addition to the washing machine, the selective addition to the wash and the rinse step, and the layering of different perfume choices to the wash and rinse wash process.

A set of usage instructions for selecting and dosing the perfume compositions into the neutral scented base composition may be provided in the kit, and/or on a location such as a pamphlet, a computer screen, a printed ticket, a kiosk, a sign, a product container, an advertisement, a product display, an Internet website, a video, and a combination thereof, preferably the set of usage instructions are provided on the container, a product display, or a combination thereof, as these locations are easy to reference. More preferably, the set of usage instructions are provided on the perfume container, as the set of usage instructions is thus unlikely to become lost and/or separated from the perfume composition when it is needed. Preferably, the set of usage instructions typically includes a recommendation to use the laundry detergent composition with the perfume composition. In a preferred embodiment, the set of laundering instructions also contain a reference to the laundry detergent composition, the fabric conditioning composition, and/or the perfume composition. More preferably, the reference is the actual name of the multiple products in a kit. Without intending to be limited by theory, it is believed that such a reference may significantly reduce consumer confusion and undesirable cross-reactions and interactions between incompatible ingredients.

The kit according to the present invention may comprise one or more of a perfume composition which is of a given scent which may be useful to use in combination for laundry cleaning of fabrics at different stages of the overall laundry process i.e. a given scent may be added during the wash cycle and another scent may be added for the rinse cycle. Different or similar scents may be combined at different stages of the laundry process.

The perfume composition of the present invention may also be packaged in containers, unit dose packets such as in the form of beads, flakes, chips, pellets, films, suppositories and/or bags or in multi-dose dispensers.

In addition the container for the perfume composition may be designed in a way to make the link with laundry products. Example of such container is described in U.S. Pat. No. 4,884,704. This container which makes use of a bottle whose appearance is transformed by an ornamental fabric casing. The means for containing the neutral scented base compositions may be a container such as a box, bottle, a pouch, an envelope, a can, a tube, an atomizer, an aerosol, beads, flakes and bags can or be dispensing means.

The container may further contain a dosing device and/or an applicator device such as a scoop, a measuring cup, a pour spout, etc. Solid and granular neutral scented base compositions are typically provided in a box, or a film pouch bottle, preferably a cardboard box or a plastic box, and more preferably a laminated cardboard box, or a plastic box. Without intending to be limited by theory, it is believed that a laminated cardboard box and/or a plastic box may be especially advantageous, as these boxes may be easily recyclable, and may also be adjusted to provide desirable properties, such as a watertight seal, moisture resistance, reclosability, etc. Liquid and gel-type unscented base compositions are preferably provided within a plastic bottle, more preferably a recyclable plastic bottle such as a polyethylene and/or polypropylene bottle, and/or a laminated film pouch.

The means for selecting, dosing and dispensing the perfumes can be dispensers in the form of physical form of the perfume itself i.e. a preferred way for dosing and mixing solid perfumes are beads. Preferred ways for dosing and dispensing liquid perfume composition are drops, beads or sprays. This allows the perfume compositions to be rapidly dosed and mixed and provide excellent means to provide the benefits of the present invention. Both the perfume beads and perfume sprays and/or drops of the present invention can be selected from perfume beads or spray bottles or dropper bottles calibrated to deliver a predetermined amount. When perfume beads or pouches are used, it is preferred that a water soluble material be used for manufacturing said beads or pouches. Suitable water soluble material for use herein will be easily recognized by those skilled in the art of formulating unit doses. Examples of such suitable material include but are not limited to hard gelatine, soft gelatine, polyvinyl alcohol, hydroxypropyl methylcellulose, polyvinyl pyrrolidine, sugar, sugar derivatives, starch, starch derivatives, zeolites, effervescent materials, and mixtures thereof. Preferably, water soluble material for manufacturing said beads comprise polyvinyl alcohol. In a preferred execution, the water soluble material comprises a polyvinyl alcohol/carboxylate copolymer resin, preferably supplied by Mono-Sol, Ind., US under the tradename M8630™.

In an alternative embodiment, the material for manufacturing said beads or pouches is preferably a soft material so as to permit said beads or pouches to be easily broken or torn by the user thereby dispensing said perfume composition into the neutral scented base composition in a convenient way. Suitable material for use herein will be easily recognized by those skilled in the art of formulating unit doses. Material for use herein shall be however sufficiently resistant to contain the corresponding compositions. The beads or pouches are preferably provided with a line of weakness so as to allow the user to easily tear the pouches and dispense the contained compositions.

The perfume composition is dosed into the neutral scented base composition. The perfume composition can also be layered to allow mixing of different perfume additive for the main wash and/or the rinse.

Preferred way of the perfume composition of the present invention may also be packaged in containers, unit dose packets or in multi-dose dispensers.

Highly preferred dispensing means for use in the kit of the present invention comprise droppers, sprays, bowls, cups, caps, nozzle, outlet, discs, washing machine dispensers, dispensing devices, or a combination thereof.

It is to be understood that the means for dispensing the perfume composition may be connected to or a part of the means for containing the base compositions. For example, the containing means may be a bottle, an atomizer or an aerosol can, and the dosing means may be the cap, a bowl, a nozzle or outlet of the atomizer or the aerosol can.

The base composition(s) can be packaged in a separate or combined container for use as a scent customized laundry kit. Upon discharge of the base composition from for example a squeezable container a sheering down is experienced which permits easy mixing with the perfume composition. It is to be understood that the means for dosing the perfume composition may be connected to or a part of the means for containing the base compositions. These means for dosing can be used as means for mixing as well. For example, a separate bowl can be used to dose and serve as a mixing vehicle for mixing the perfume composition with one or more of the unscented base compositions.

Preferably, the containers useful herein have a similar design, shape, colour or colours, construction material, and/or functional characteristic which reinforces to a consumer that the multiple products herein are part of a kit. For example, similar or identical caps, bottle shapes, applicators/pour spouts, dosing devices, etc.

In an alternative embodiment of the present invention the containers in the kit of the present invention are inter-related in that they physically fit together to reduce wasted space, and to further imply that they are to be used together to provide superior results. For example, the containers for the multiple products herein may be designed, sized, and/or manufactured with the kit in mind, such that they are easily stacked, connected, organized etc. Thus, it is preferred that these containers physically fit together with a minimum of wasted space. This allows more kits to be placed within a given volume of space and thereby reduces the per unit storage space, shelf space, etc. required by the manufacturer, the distributor, the seller, and/or the consumer. This is especially preferred in locations where space is expensive or at a premium, as for example, on a convenience store shelf or in a consumer's storage space.

A preferred embodiment of this invention includes a neutral scented base detergent composition in combination with an unscented base fabric conditioning composition. The incorporation of fabric softeners, in fabric conditioning compositions, especially the preferred cationic i.e.; quaternary ammonium compounds in combination with anionic base detergent compositions have found to be a high performing method imparting effective softening properties without the stability problems previously associated with cationic fabric softener/anionic detergent mixtures.

With the foregoing description of the invention, those skilled in the art will appreciate that modification may be made to the invention without departing from the spirit thereof. Therefore, it is not intended that the scope of the invention be limited to the specific embodiments illustrated and described.

The base compositions and the perfume compositions of the present invention may be separately provided in a kit or package form ready for use by the consumer, either professional or personal to form a laundry product. It is preferred to mix the compositions in a mixing vessel for subsequent use in the laundry process. The mixing vessel may be a part of the container such as a dosing chamber forming integral part of the container, a separate bowl or a dispensing device.

The kit provided in accordance with this invention comprises those containers. In the most convenient form, there will be three containers, two containing the base compositions, the other the perfume composition. Particularly when liquid base compositions and liquid perfume composition is used, it may be convenient to package the base compositions in separate containers one with the detergent composition, the other with the fabric conditioning composition. With both embodiments of the invention, the ingredients in the composition of the first and second container will include perfume performance enhancing agents which, upon mixing with the perfume composition, provides superior perfume delivery into the wash.

The present invention also provides kits which are useful for carrying out the method for a laundry operation according to the present invention. The present kits comprise a first container means containing the above-described neutral scented base compositions and perfume compositions. The kit also comprises other container means containing solutions necessary or convenient for carrying out the invention. The kit may also contain written information, such as procedures for carrying out the present invention or analytical information, such as the amount of composition contained in the first container means.

The kits according to the present invention will also typically include means for packaging the container means and the selecting, dosing and dispensing means. Such packaging means may take the form of a cardboard or paper box, a plastic or foil pouch, etc. The present kits will also usually include written instructions which describe how to select, dose, mix and dispense the perfume composition to the base compositions. It is to be understood that the written instructions may be on any of the container means, the administering means, or the packaging means, in addition to being present on a separate piece of paper.

A preferred embodiment of the present method features the perfume compositions as a liquid composition. The liquid perfume composition can be dosed and mixed into the neutral scented base compositions or to the laundry fabrics or to the washing liquor as drops, sprays or beads. This allows the perfume compositions to be rapidly dosed and/or mixed and provides excellent means for delivering the benefits of the present invention. The sprays and/or drops and/or beads of the present invention can be a selected from standard spray bottles or dropper bottles calibrated to deliver a predetermined amount.

Preferred kit according to the present invention are those whereby the neutral scented base composition is in liquid form and the perfume composition is in liquid form whereby the viscosity of the base scented liquid composition is greater than the viscosity of the perfume composition.

Preferred kit are those wherein said perfume compositions is in Newtonian fluid form and has a viscosity of from 1 to no more than about 1,200 mPa·s.
Specification: Viscosities (mPa·s) for perfume vehicle materials at 20C: Water: 1
Propanediol: 100
Glycerine (99%): 1150
No spindle needed since these materials are Newtonian fluid.
Specification: Viscosities for the neutral scented base composition—note: the neutral scented base composition can be a Newtonian fluid or can be shear thickening.

Preferred kit according to the present invention are those whereby the base neutral scented compositions and the perfume compositions are liquid compositions having a physical form which preferably ranges from a pourable liquid, a pourable gel to a non-pourable gel. These forms are conveniently characterized by the product viscosity. In these definitions, and unless indicated explicitly to the contrary, throughout this specification, all stated viscosities are those measured at a shear rate of 21 s-1 and at a temperature of 25° C.

Liquid compositions according to any aspect of the present invention preferably have a viscosity of no more than 1,500 mPa·s, more preferably no more than 1,000 mPa·s, still more preferably, no more than 500 mPa·s.

Compositions according to any aspect of the present invention which are pourable gels, preferably have a viscosity of at least 1,500 mPa·s but no more than 6,000 mPa·s, more preferably no more than 4,000 mPa·s, still more preferably no more than 3,000 mPa·s and especially no more than 2,000 mPa·s.

Compositions according to any aspect of the present invention which are non-pourable gels, preferably have a viscosity of at least 6,000 mPa·s but no more than 12,000 mPa·s, more preferably no more than 10,000 mPa. s, still more preferably no more than 8,000 mPa·s and especially no more than 7,000 mPa·s.

Base neutral scented compositions can also include the snap-back gels described in US24058834A1.

Other preferred kit of the present invention are those with neutral scented base compositions comprising enzymes in combination with perfume compositions comprising enzyme reactive perfumes such as terpenes, ketones, aldehydes and mixtures thereof. Examples are described in US 2005/0130864.

In another embodiment of the present invention, the set of instructions directs the user to choose and/or combine one or more neutral scented base compositions to achieve the desired benefit. For example, the base composition is a general neutral scented detergent composition is useful for laundry cleaning in the home of the present invention. For customization, the base neutral scented detergent composition may be combined with the perfume composition to customize the method according to the present invention. A similar approach is possible with the neutral scented liquid fabric softener. The instructions may include various types of fabrics, stains, the corresponding additives, and the effective amount (which may be presented in one or more dosage units) of the specific compositions recommended for enhancing or delivering the desired benefits in terms of perfume, cleaning and softening performance. The neutral scented base compositions of the method of the present invention and the perfume composition may be packaged in containers, unit dose packets or in multi-dose dispensers. The dispenser may comprise a dispensing means, such as a spout, a pump, a spray nozzle, and a measuring means for precise dosing, such as an accurated, graduated, or inscribed cup, dropper, syringe, and the like. The dispensing means can also be accurated, graduated or inscribed to serve as the measuring means. The instructions may also direct the user to choose a pretreating composition, which is to be applied to the laundry fabrics prior to the laundering process, which is to be applied during the laundering process in the device, to enhance or deliver the desired benefits of the method of the present invention

A set of usage instructions may be provided in the kit, and/or on a location such as a pamphlet, a computer screen, a printed ticket, a kiosk, a sign, a product container, an advertisement, a product display, an Internet website, a video, and a combination thereof, preferably the set of usage instructions are provided on a product container, a product display, or a combination thereof, as these locations are easy to reference. More preferably, the set of usage instructions are provided in the kit and/or on the containers for the multiple products, as the set of usage instructions is thus unlikely to become lost and/or separated from the relevant composition when it is needed. The set of usage instructions typically includes a recommendation to use the laundry detergent composition with the fabric conditioning composition and the perfume composition. In a preferred embodiment, the set of laundering instructions also contain a reference to the laundry product composition, the laundry detergent composition, the fabric conditioning composition, and/or the perfume composition. More preferably, the reference is the actual name of the multiple products in the kit. Without intending to be limited by theory, it is believed that such a reference may significantly reduce consumer confusion and undesirable cross-reactions and interactions between incompatible ingredients.

In addition, the container for the perfume composition may be designed in a way to make the link with laundry products. Example of such container is described in U.S. Pat. No. 4,884,704. This container which makes use of a bottle whose appearance is transformed by an ornamental fabric casing.

In addition to any of the above recommendations, the set of usage instructions will typically also include general instructions which recommend how to apply each of the multiple products to a fabric article, e.g., indirectly by adding the laundry detergent composition to an automatic washing machine prior to the beginning of the wash cycle.

Method for a Laundry Operation

In another embodiment, the present invention provides a method for a laundry operation comprising the steps of: a) selecting a neutral scented base composition; b) selecting a perfume composition; c) dosing and dispensing the perfume composition into the neutral scented base composition thereby forming a unitized dose of customized laundry product; d) dispensing the unitized dose of customized laundry product formed in step c) to the laundry washing liquor.

The method according to present invention allows for customizing perfumed laundry compositions by selecting and dosing the perfume compositions in response to the individual needs of the user. While carrying out the method according to the present invention, the user is allowed to formulate his scent customized laundry products which would be most suitable for washing the particular laundry. Accordingly, the consumer is offered the flexibility to formulate and customize a ready-to-use unitized dose of scent customized laundry product to be used in the context of a unitary laundry operation.

Preferably, the neutral scented base composition for use in the present method is selected from a neutral scented base detergent composition and/or a neutral scented fabric conditioning composition.

According to a preferred embodiment, the dosing and dispensing of the perfume composition is operated by using means selected from the group consisting of droppers, sprays, bowls, cups, caps, nozzle, outlet, discs, washing machine dispensers, dispensing devices, or a combination thereof. Preferably the means for use in the method of the present invention are calibrated to deliver a predetermined amount of said perfume composition. More preferably said means comprise beads, bags, flaxes and discs having a unitized dose of said perfume composition.

In a preferred method according to the invention, the means for dosing and/or dispensing said neutral scented base composition and said perfume composition are similar or identical in shape. According to this preferred embodiment, said means are preferably selected from the group consisting of boxes, bottles, pouches, envelopes, cans, tubes, atomizers, aerosols, beads, flakes, bags, and mixtures thereof.

According to another preferred method of the invention, said perfume composition is dispensed into the neutral scented base composition via the washing machine dispenser and/or via dispensing devices. Accordingly, the unitized dose of customized laundry product which is formed when carrying out the method according to the present invention is preferably dispensed to the laundry washing liquor via the washing machine dispenser and/or via dispensing devices.

Typically, the method according to the invention is preferably characterized in that the perfume composition is admixed to said base composition prior to adding into the laundry washing liquor. More preferably, said perfume composition is admixed to said base composition in amounts so that the weight ratio of the perfume composition to the base composition is in the range from about 1:5 to about 1:100, preferably from about 1:10 to about 1:75.

A specifically preferred method for a laundry operation according to the invention is a method whereby said neutral scented base composition and said perfume composition are liquid, wherein said neutral scented base composition is contained in a bottle, and wherein the means for dosing and dispensing said perfume composition comprises a range of perfume droppers and a dispensing device which fits on top of said bottle for dispensing said perfume composition into said neutral scented base composition.

Another specifically preferred method for a laundry operation according to the invention is a method whereby said neutral scented base composition and said perfume composition are liquid, wherein said neutral scented base composition is contained in a bottle, and wherein the means for dosing and dispensing said perfume composition is provided as a range of perfume discs, wherein said bottle further comprises a dosing chamber integrated on top of said bottle for connecting with said perfume discs.

Yet another preferred method according to the invention is characterized in that the neutral scented base composition is contained in beads and the means for selecting, dosing and dispensing the perfume composition is provided as a range of beads.

A preferred embodiment of the present invention further includes a method for a laundry operation wherein the neutral scented base composition comprises from 0.01% to 10% of a non residual perfume which has at least 50% of components with a ClogP less than 2.5, ClogP being the calculated octanol/water partitioning coefficient (P) expressed as the logarithm to the base 10, logP and wherein said perfume composition comprises from 0.01% to 10% of a perfume which has at least 50% of components with a ClogP more than 2.7, ClogP being the calculated octanol/water partitioning coefficient (P) expressed as the logarithm to the base 10, logP.

In another preferred execution, the method of the invention is characterized in that the perfume composition is a perfume or mixture of perfume ingredients comprising at least 25%, more preferably at least 50%, and even more preferably at least 75%, by weight of the perfume composition, of perfume ingredients with a ClogP equal or greater than 2.7, preferably equal or greater than 2.9, more preferably equal or greater than 3.0.

One preferred method for a laundry operation according to the invention is a method whereby said neutral scented base composition and said perfume composition are in liquid form, and wherein the viscosity of said liquid scented base composition is greater than the viscosity of said perfume composition. According to an alternative preferred execution of the method of the invention whereby the neutral scented base composition and the perfume composition are in liquid form, the base composition comprises enzymes and the perfume composition comprises enzyme reactive perfumes such as terpenes, ketones, aldehydes, and mixtures thereof.

Assembly

According to another embodiment of the present invention, an assembly is provided comprising a perfume composition, preferably a plurality of perfume compositions, said assembly further comprising means to instruct a consumer on how to select and/or dose and/or dispense one or more of said perfume compositions into a neutral scented base composition thereby forming a unitized dose of customized laundry product for use in a laundry operation. Preferably, the perfume compositions release from about 0.2ml to about 1 ml of perfume in the washing machine dispenser at water pressure of from about 2/min to about 51/min within 3 minutes.

Preferably, the assembly according to the present invention comprises a set of instructions directing the user to choose and/or combine one or more perfume compositions with a neutral scented base composition. In alternative execution of the present invention, the assembly comprises a set of instructions directing the user to choose and/or combine one or more perfume compositions to achieve the desired benefit.

Yet another preferred assembly according to the invention is characterized in that the neutral scented base composition is selected from a neutral scented base detergent composition and/or a neutral scented fabric conditioning composition.

Article of Manufacture

According to yet another embodiment of the present invention, an article of manufacture is provided, said article further comprising means for the consumer to select, dose and dispense said perfume composition into a neutral scented base composition thereby forming a unitized dose of customized laundry product for use in a laundry operation. Preferably, said perfume composition is selected, dosed and ultimately dispensed into the laundry washing liquor via the washing machine dispenser.

In a preferred execution of the present invention, said means comprises beads, bags, flaxes, and discs having a unitized dose of perfume.

The perfume composition is dispensed into the neutral scented base composition and ultimately to the laundry washing liquor in the washing machine preferably via the washing machine dispenser and/or via a dispensing device. Preferred way of dispensing for perfumes can be dispensers in the form of physical form of the perfume itself whereby the beads themselves serve as dispensing means. Highly preferred ways for dispensing perfume composition are drops, beads or sprays. This allows the perfume compositions to be rapidly dosed and provide excellent means to provide the benefits of the present invention. Both the perfume beads and perfume sprays and/or drops of the present invention can be a selected from standard perfume beads or spray bottles or dropper bottles calibrated to deliver a predetermined amount or being present as unitized dosage.

Examples of the present invention are set forth hereinafter by way of illustration and are not intended to be in any way limiting of the invention.

### EXAMPLE 1

A kit according to the present invention includes a clear neutral scented base liquid laundry detergent composition, a milky white neutral scented base liquid fabric conditioning composition, and a liquid perfume composition are provided in three separate containers, for use on a fabric article. All three containers are further packaged within a cardboard box to form the kit of the present invention.

The container for the clear neutral scented base liquid laundry detergent composition and the milky white scented base liquid fabric conditioning composition are bottles made out of transparent PET bottle. The liquid perfume composition is provided as a range of scent droppers. The kit also contains a dosing bowl which fits on top of the bottle for dispensing the scent into the liquids. In this example the dosing bowl also serves as the dispensing device. The kit includes a set of usage instructions which specifically refer to the neutral scented base fabric conditioning composition, the unscented base laundry detergent composition, and the perfume composition.

Example of instructions are set out herein below:

[image]

[image]

[image]

[image]

[image]

The following table describes the compositions of the detergent, liquids fabric softener and a perfume formulation.

Neutral scented liquid detergent

| | Chemical content |
|---|---|
| Composition (pH 7.5) | (%) |
| Propanediol | 10.00 |
| Monoethanolamine | 5.00 |
| Citric Acid | 4.00 |
| C12/14 Alkyldimethylamine Oxide (OG Base) | 5.00 |
| Non Ionic 45-8 | 17.000 |
| Monoethanolamine Borate | 2.00 |
| Calcium Chloride | 0.03 |
| Trans Sulphated Ethoxylated Hexamethylene Diamine | |
| polymer | 1.00 |
| neutral perfume based on ionone and musk | 0.20 |
| Protease | 0.800 |
| Silicone | 0.020 |
| Dye | 0.00005 |
| H2O (Demin.) | Balance |
| | 100 |

Neutral Scented Liquid Fabric Softener

| | Chemical |
|---|---|
| Composition (pH 3.5) | content(%) |
| DEEDMAC (BFA base) (Dialkyl Diester Quaternary) | 15 |
| Silicone | 0.1 |
| 1Hydroxyethane-1,1 Diphosphonate Monosodium salt | 0.01 |
| solution (NaHEDP) | |
| HCl | 0.02 |
| Citric Acid | 0.1 |
| Calcium Chloride | 0.05 |
| neutral perfume having <2.5 Clog P | 0.7 |
| Water | Balance |
| | 100 |

Examples of a Perfume Additive

| | Example 1 | Example 2 | Example 3 |
|---|---|---|---|
| Composition (pH 3.5) | Wt % | Wt % | Wt % |
| Perfume with > on average 2.5 | 6 | 15 | 40 |
| Clog P | | | |
| Di propylene glycol | balance | balance | balance |

The set of laundering instructions also recommend that best results are achieved when the consumer uses the laundry detergent composition in combination with the fabric conditioning composition and the perfume composition. The fabric conditioning composition has a similar set of instructions which refer to both the neutral scented base laundry detergent composition and the perfume composition by name. The perfume composition has a set of fabric treatment instructions which refers to both the neutral scented base laundry detergent composition and the neutral scented base fabric conditioning composition by name, and also has a fabric treatment recommendation to use the perfume composition in combination with the laundry detergent composition and the fabric conditioning composition. The fabric treatment recommendation contains a dosing and mixing pre-laundering recommendation and a pre-conditioning recommendation that the best results are achieved by using the perfume composition before the laundering cycle and before the conditioning cycle for succeeding uses. The following picture visualized the product combination.

[image]

[image]

The perfume composition container, the neutral scented base laundry detergent composition container, and the neutral scented base fabric conditioning composition container have a similar construction, in that they are made of the same plastic material, similar graphics, and a similar shape; however, the sizes are different.

### EXAMPLE 2

A neutral scented liquid laundry detergent composition in a unitized dose, a neutral scented liquid fabric conditioning composition in a unitized unit dose, and a liquid perfume composition in a unitized dose, are provided in a single kit. All compositions are in the form of beads. All compositions are packaged within individual containers, which easily fit together within a cardboard box to form the fabric care kit. The kit is thus convenient and easy to store, stack, display, etc. Furthermore, all containers are cans and have a similar shape, the same brand name, and almost identical graphics, all of which are reproduced on the outside of the kit.

[image]

[image]

| Ingredients: | Neutral Scented | | | |
|---|---|---|---|---|
| (% by weight) | detergent for beads | | | |
| Dodecylbenzene | 21 | 23 | 19 | 25 |
| sulphonic acid | | | | |
| C12-14 alcohol, 7x | 21 | 19 | 22 | 18 |
| ethoxylated | | | | |
| C8-C10 amido propyl | 1.1 | — | — | — |
| dimethylamine | | | | |
| Citric acid | 1.7 | 2.0 | — | 1.7 |
| C12-C18 alkyl fatty | 14 | 15 | 18 | 14 |
| acid | | | | |
| Hydroxyethane | 0.75 | 0.45 | 0.90 | — |
| diphosphonic acid | | | | |
| Diethylene Triamine | — | — | — | 0.41 |
| Penta methylene | | | | |
| phosponic acid | | | | |
| Protease/amylase | 1.6 | 1.6 | 1.6 | 1.6 |
| enzymes | | | | |
| Magnesium chloride | 0.10 | — | 0.11 | — |
| Potassium sulfite | 0.12 | 0.14 | 0.16 | — |
| Polyethyleneimine, | 1.3 | 1.3 | 1.6 | 1.3 |
| 20x ethoxylated | | | | |
| Zwitterionic | 2.5 | 1.2 | 2.8 | 2.5 |
| polyamine | | | | |
| Optical brightener | 0.22 | 0.21 | 0.22 | 0.19 |
| Hydrogenated castor | 0.21 | 0.20 | 0.21 | — |
| oil | | | | |
| Propylene Glycol | 4.0 | 5.2 | 7.0 | 15 |
| Glycerine | 9.5 | 7.5 | 7.5 | — |
| Polydimethylsiloxane | — | 2.0 | — | — |
| Monoethanolamine | 9.8 | 10.7 | 9.0 | 10.6 |
| Odour counteractant, | 2.4 | 2.4 | 2.4 | 2.2 |
| dyes, minors, Sodium | | | | |
| hydroxide | | | | |
| Water | 8.7 | 8.1 | 7.5 | 7.5 |

Dodecylbenzene sulphonic acid is commercially available from Ifrachem.
C12-14 alcohol, 7× ethoxylated is commercially available from Sasol.
C8-C10 amido propyl dimethylamine is commercially available from Akzo Nobel Chemicals LTD.
Citric acid is commercially available from Citrique Belge NV.
C12-C18 alkyl fatty acid is commercially available from Akzo Nobel Chem. GMBH.
Hydroxyethane diphosphonic acid is commercially available from Solutia Europe NV.
Diethylene Triamine Penta methylene phosponic acid is commercially available from Albright & Wilson LTD.
Enzymes are proteolitic and amylolytic enzyme solutions commercially available from respectively Genencor and Novozymes.
Magnesium chloride is commercially available from Nedmag.
Potassium sulfite is commercially available from BASF.
Polyethyleneimine ethoxylate PEI600 E20, is commercially available from BASF.
Zwitterionic polyamine is Lutensit Z96™, commercially available from BASF.
Optical brightener is disodium 4,4′-bis-(2-sulphostyryl)biphenyl, commercially available from Ciba AG.
Hydrogenated castor oil is commercially available from Brazil Oleo De Mamona.
Propylene glycol is commercially available from BASF.
Glycerine is commercially available from NAT OLEO.
Polydimethylsiloxane is commercially available from Dow Corning.
Monoethanolamine is commercially available from Sasol.

Example of the Fabric Enhancer in the Inventions:

| | Example 1 | Example 2 | Example 3 |
|---|---|---|---|
| Chemical | Wt % | Wt % | Wt % |
| Softener Active (85%)¹ | 75.08 | 77.087 | 87.565 |
| TMPD | 14.73 | — | — |
| Canola fatty acid | 1.84 | — | — |
| 1,4-CHDM | — | 7.174 | — |
| Neodol 91-8 | — | 6.696 | 7.606 |
| Cocoamide 6EO | 4.05 | — | — |
| Hexylene glycol | — | 4.783 | — |
| Perfume | 4.30 | 4.185 | 4.754 |
| Acid Blue 80 dye | 0.00075 | 0.00075 | 0.00075 |

¹Di(acyloxyethyl)(2-hydroxy ethyl) methyl ammonium methyl sulfate wherein the acyl group is derived from partially hydrogenated canola fatty acid. Active contains about 7.5% hexylene glycol and 7.5% of ethanol solvent which is about 95% ethanol and about 5% water.

Examples of a Perfume Additive:

| | Example 1 | Example 2 | Example 3 |
|---|---|---|---|
| Composition (pH 3.5) | Wt % | Wt % | Wt % |
| Perfume with > on average 2.5 Clog | 3 | 20 | 45 |
| P | | | |
| Di propylene glycol | balance | balance | balance |

The liquid compositions were packed into film pouches using vacuum-formed, horizontal form-fill-seal process, each pouch containing about 50 ml of liquid. The film was made from a polyvinyl alcohol/carboxylate copolymer resin (M8630™ Mono-Sol, Ind., US). The bead containing the neutral scented liquid laundry detergent composition is open and the contained composition poured into one compartment of the dispensing drawer of the washing machine. The perfume bead is then added into the compartment of the dispensing drawer containing said neutral scented liquid laundry detergent composition. One bead containing the neutral scented liquid fabric conditioning composition is put into another compartment of the dispensing drawer. The dissolution and disintegration profiles of each of pouched compositions are good.

A set of usage instructions is provided on the side of the kit, which refers to each of the laundry detergent composition, the fabric conditioning composition.

Such a fabric care method is easily understood and conceptualized by the consumer, who may easily select the desired components while being assured that they are mutually compatible, and will give the desired results.

### EXAMPLE 3

A neutral scented base laundry detergent composition, a neutral scented base fabric conditioning composition and a perfume composition are provided as a fabric care kit.

The neutral scented base laundry detergent composition container and the neutral scented base fabric conditioning composition container have a similar construction, in that they are made of the same plastic material, similar graphics, and a similar shape. The sizes of the corresponding containers are however different. The perfume compositions are container is a can. The perfume is added into a bag which is put in the dispenser of the washing machine quickly dissolving the perfume into the wash liquor.

[image]

[image]

DOSAGE RECOMMENDATION

| LIQUID DETERGENT | | FABRIC SOFTENER | | LAUNDRY SCENT BAG | |
|---|---|---|---|---|---|
| Soil | | Preferred | | Preferred | |
| level of | Amount of | amount of | Amount of | amount of | Amount of |
| your wash | product | softness | product | scent | product |
| Light/Normal | 50 ml | Regular softness | 35 ml | Normal scented | 1 bag |
| Normal/ | 75 ml | Extra softness | 50 ml | A bit more scent | 2 bags |
| Heavy | | | | | |
| Very heavy | 100 ml | | | A lot of scent | 3 bags |

The neutral scented laundry detergent and the neutral scented fabric softener are as described in example 1. The perfume bag is a commercial tea bag which contains 10 grams of light sodium carbonate in particles of about 0.5 mm diameter with 10% sprayed on perfume of the invention.

### EXAMPLE 4

A kit according to the present invention includes a neutral scented base liquid laundry detergent composition, a clear neutral scented base liquid fabric conditioning composition, and a liquid perfume composition. They are provided in three separate containers, for use on a fabric article.

The container for the neutral scented base liquid laundry detergent composition and the clear neutral scented base liquid fabric conditioning composition are bottles made out of transparent PET bottle. The liquid perfume composition is provided as a range of scent discs. The bottles contain a dosing chamber integrated with the bottles. The scent disc is then connected to this dosing chamber.

The detergent, liquid fabric softener and perfume composition are the same as in example 1.

[image]

[image]

In all examples, the addition of the perfume composition can be done to the neutral scented detergent base formulation and/or to the neutral scented fabric conditioner base formulation. Such an addition can also conveniently be made in the dispenser of automatic washing machines; i.e. before starting the laundry cycle, an amount of neutral scented base fabric conditioning composition in liquid form is first poured into the dispenser of the washing machine, and the specific dose of perfume composition is added to said fabric softening composition sitting in the dispenser, and is dispersed therein. Different perfume additives can also be mixed and blended to personalize a scent in either the main wash or the rinse. Similarly, different perfume additives can be used with the detergent and the fabric softener.

The resulting mixture is then brought into contact with the fabrics, during the rinse cycle and the perfume is released onto the fabrics.

The detergent, fabric enhancer and perfume additive formulations are as described in example 1.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for a laundry operation comprising the steps of:
a) selecting a neutral scented base composition;
b) selecting a perfume composition;
c) dosing and dispensing said perfume composition into said neutral scented base composition thereby forming a unitized dose of customized laundry product;
d) dispensing said unitized dose of customized laundry product formed in step c) to the laundry washing liquor.

2. A method according to claim 1 wherein said unitized dose substantially corresponds to the quantity of customized laundry product desired for a laundry operation.

3. A method according to claim 1 wherein said dosing and dispensing of said perfume composition is operated by using means selected from the group consisting of droppers, sprays, bowls, cups, caps, nozzle, outlet, discs, washing machine dispensers, dispensing devices, or a combination thereof.

4. A method according to claim 3 whereby said means are calibrated to deliver a predetermined amount of said perfume composition.

5. A method according to claim 3 wherein said means comprise beads, bags, flaxes and discs having a unitized dose of said perfume composition.

6. A method according to claim 3 wherein the means for dosing and/or dispensing said neutral scented base composition and said perfume composition are similar or identical in shape, and wherein said means are selected from the group consisting of boxes, bottles, pouches, envelopes, cans, tubes, atomizers, aerosols, beads, flakes, bags, and mixtures thereof.

7. A method according to claim 1 whereby said perfume composition is dispensed via the washing machine dispenser and/or via dispensing devices.

8. A method according to claim 1 wherein said neutral scented base composition is selected from a neutral scented base detergent composition and/or a neutral scented fabric conditioning composition.

9. A method according to claim 1 wherein said perfume composition is admixed to said base composition prior to adding into the laundry washing liquor.

10. A method according to claim 9 wherein said perfume composition is admixed to said base composition in amounts so that the weight ratio of the perfume composition to the base composition is in the range from about 1:10 to about 1:75.

11. A method according to any of claim 3 wherein said neutral scented base composition and said perfume composition are liquid, wherein said neutral scented base composition is contained in a bottle, and the means for dosing and dispensing said perfume composition comprises a range of perfume droppers and a dispensing device which fits on top of said bottle for dispensing said perfume composition into said neutral scented base composition.

12. A method according to any of claim 3 wherein said neutral scented base composition and said perfume composition are liquid, wherein said neutral scented base composition is contained in a bottle, and the means for dosing and dispensing said perfume composition is provided as a range of perfume discs, wherein said bottle further comprises a dosing chamber integrated on top of said bottle for connecting with said perfume discs.

13. A method according to any of claim 3 wherein said neutral scented base composition is contained in beads and said means for dosing and dispensing said perfume composition is provided as a range of beads.

14. A method according to claim 1 wherein said neutral scented base composition comprises from about 0.01% to about 10% of a non residual perfume which has at least about 50% of components with a ClogP less than about 2.5, ClogP being the calculated octanol/water partitioning coefficient (P) expressed as the logarithm to the base 10, logP and wherein said perfume composition comprises from about 0.01% to about 10% of a perfume which has at least about 50% of components with a ClogP more than about 2.7, ClogP being the calculated octanol/water partitioning coefficient (P) expressed as the logarithm to the base 10, logP.

15. A method according to claim 14 wherein said perfume composition is a perfume or mixture of perfume ingredients comprising at least about 25% by weight of the perfume composition, of perfume ingredients with a ClogP equal or greater than about 2.7.

16. A method according to claim 1 wherein said neutral scented base composition and said perfume composition are in liquid form, and wherein the viscosity of said liquid scented base composition is greater than the viscosity of said perfume composition.

17. A method according to claim 1 wherein said neutral scented base composition and said perfume composition are in liquid form, and wherein said base composition comprises enzymes and said perfume composition comprises enzyme reactive perfumes such as terpenes, ketones, aldehydes and mixtures thereof.

18. A kit for providing a unitized dose of scented customized laundry product comprising:
a) a selection from a neutral scented base composition;
b) a selection from a class of perfume compositions;
c) means for the consumer to select, dose and dispense said perfume compositions into said neutral scented base composition thereby forming a unitized dose of customized laundry product for use in a laundry operation.

19. A kit according to claim 18 wherein said means comprise droppers, sprays, bowls, cups, caps, nozzle, outlet, discs, washing machine dispensers, dispensing devices, or a combination thereof.

20. A kit according to claim 19 whereby said means are calibrated to deliver a predetermined amount of said perfume composition.

21. A kit according to claim 18 wherein said means comprise beads, bags, flaxes having a unit dose of said perfume composition.

22. A kit according to claim 18 wherein the means for dosing and/or dispensing said neutral scented base composition and said perfume composition are similar or identical in shape, and wherein said means are selected from the group consisting of boxes, bottles, pouches, envelope, cans, tubes, atomizers, aerosols, beads, flakes, bags, and mixtures thereof.

23. A kit according to claim 18 further comprising instructions to dispense said perfume composition into said base compositions prior to adding into the laundry washing liquor.

24. A kit according to claim 18 wherein said neutral scented base composition and said perfume composition are liquid, wherein said neutral scented base composition is contained in a bottle, and the means for selecting, dosing and dispensing said perfume composition is provided as a range of perfume droppers, said kit further comprising a dispensing device which fits on top of said bottle for dispensing said perfume composition into said neutral scented base composition.

25. A kit according to claim 18 wherein said neutral scented base composition and said perfume composition are liquid, wherein said neutral scented base composition is contained in a bottle, and the means for selecting, dosing and dispensing said perfume composition is provided as a range of perfume discs, the bottle further containing a dosing chamber integrated on top of said bottle for connecting with said perfume discs.

26. A kit according to claim 18 wherein said neutral scented base composition is contained in beads and said means for selecting, dosing and dispensing said perfume composition is provided as a range of beads.

27. An assembly comprising a plurality of perfume compositions, said assembly further comprising means to instruct a consumer on how to select and/or dose and/or dispense one or more of said perfume compositions into a neutral scented base composition thereby forming a unitized dose of customized laundry product for use in a laundry operation.

28. An assembly according to claim 27 wherein said neutral scented base composition is selected from a neutral scented base detergent composition and/or a neutral scented fabric conditioning composition.

29. An assembly according to claim 27 wherein said perfume compositions release about 0.2-1 ml of perfume in the washing machine dispenser at water pressure from about 2-51/min within about 3 minutes.

30. An article of manufacture comprising a perfume composition, said article further comprising means for the consumer to select, dose and dispense said perfume composition into a neutral scented base composition thereby forming a unitized dose of customized laundry product for use in a laundry operation.

31. An article of manufacture according to claim 30 wherein said means comprises beads, bags, flaxes, and discs having a unitized dose of perfume.
